(19) United States
(12) Patent Application Publication
(10) Pub. No.: US 2010/0210652 A1
(43) Pub. Date: Aug. 19, 2010

(54) Method For Controlling Fungal Pests

(76) Inventors: Gerd Stammler, Dossenheim (DE); Barbara Nave, Ruppertsberg (DE); Ulrich Schöfl, Apex, NC (US); Reinhard Stierl, Kaohsiung County (TW)

Correspondence Address: BRINKS, HOFER, GILSON & LIONE, P.O. BOX 1340, MORRISVILLE, NC, 27560, US

(21) Appl. No.: 12/438,963

(22) PCT Filed: Aug. 24, 2007
(86) PCT No.: PCT/EP2007/058807

§ 371 Date: Feb. 26, 2009

(30) Foreign Application Priority Data
Aug. 28, 2006 (EP) 06119625.9

(51) Int. Cl. A01N 37/18; A01P 3/00

(52) U.S. Cl. 514/237.5; 514/622

(57) ABSTRACT

A method of controlling harmful fungi which are resistant to carboxamide fungicides consists in applying a fungicidally active amount of a compound of the general formula (I)

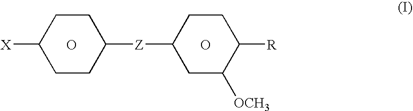

where —R denotes, for example:

—OCH₃, —OC₂H₅ or —OCH₂—C≡CH
and where —X denotes either —Cl or —F
and where —Z— denotes, for example, a group:

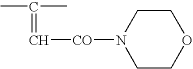

preventatively to the plants.

The present invention relates to a method of controlling harmful fungi which are resistant to carboxamide fungicides.

A large number of different groups of chemical substances have been employed for decades for controlling harmful fungi on crop plants such as cereals or grapevines. These compounds should, firstly, prevent or at least contain an attack of the crop plants by harmful fungi and, secondly, not lead to sustained damage of the crop plant at the concentration employed.

A group of fungicidal compounds which has gained economic importance are the so-called carboxamide fungicides (carboxylic acid amide fungicides) which prevent, inter alia, the phospholipid biosynthesis of the harmful fungi. The carboxamide fungicides include, inter alia, various cinnamamide derivatives (see, for example, U.S. Pat. No. 5,952,496), valinamide carbamates (see, for example, DE 4026 966), mandelamides and other carboxamide derivatives. Important constituents of commercially available products are, inter alia, the carboxamide fungicides dimethomorph, benthiavalicarb, flumorph, iprovalicarb and mandipropamid.

The cinnamic acid derivatives described in U.S. Pat. No. 5,952,496 also proved to be highly important for controlling harmful fungi. These cinnamic acid derivatives can be formulated for example as a solution, as an aqueous emulsion or as a powder preparation and applied to crop plants in this form.

In recent years, experiences in practical agriculture have shown that the repeated use of certain fungicidal active substances for controlling harmful fungi can lead to a rapid selection of those fungal strains which have developed a natural or else adapted resistance to the active substance in question. A large number of genes allow the fungi to detoxify the fungicides, which complicates an effective control of these harmful fungi using this particular active substance.

It has furthermore been found that these fungal strains frequently also develop a cross-resistance to other active substances which are based on the same mechanism of action.

This requires the use of types of active substance which are based on a different mechanism of action. However, there is only a limited number of active substances with a novel mechanism of action available, and finding novel mechanisms of action is a complicated procedure. The development of novel active substances which show no cross-resistance with the known active substances proves to be time-consuming and expensive.

An important group of fungicides which has become established against a large number of plant pathogens are active substances which share, as active principle, an engagement in phospholipid biosynthesis. These compounds affect, inter alia, the cell wall of harmful fungi. The abovementioned carboxamide fungicides belong to this group of active substances.

It is an object of the present invention to provide a novel method of controlling harmful fungi which may already be resistant to certain fungicides. The method should be simple to carry out technically, result in the efficient avoidance or elimination of harmful fungi and be applicable to various types of crop plants without damaging them.

This object is achieved by a method of controlling harmful fungi which are resistant to individual carboxamide fungicides, in which method a fungicidally active amount of a compound of the general formula (I) is applied to the plants, to the seeds and/or the soils before or after sowing the plants, or else before or after plant emergence, the treatment being, in particular, preventative.

In accordance with the method according to the invention, a fungicidally active amount of a compound of the general formula (I)

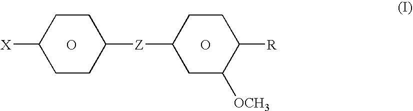

is used,
where —R denotes a radical:

—OCH₃, —OC₂H₅ or —OCH₂—C≡CH

where —X denotes either —Cl or —F
and
where —Z— denotes:

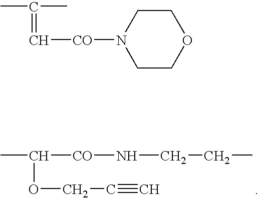

The method is particularly suitable for controlling harmful fungi of the Plasmopara type, in particular Plasmopara viticola.

In the method according to the invention of controlling harmful fungi, it is preferred to employ a compound of the general formula (I) in which

—R denotes —OCH₃,
—X denotes —Cl or —F
and —Z— denotes

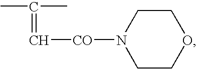

it being possible to employ the Z isomer, the E isomer or mixtures of the two isomers, or else a compound of the general formula (I) where

### —R is

—OCH₂—C≡CH

### —X is —Cl

### and —Z— is

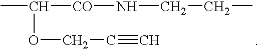

In the method, the compound of the general formula (I) or a salt of this compound is, as a rule, applied in an amount of from 1 to 1000 g/ha, or in amounts from 1 to 1000 g/100 kg of seed.

In the method of controlling harmful fungi, the compound of the general formula (I) is frequently applied to the underside of the leaves of the plants to be treated. The treated plants can, in particular, also be grapevines.

A compound of the general formula (I) can also be employed in combination with one or more other fungicides, for example also in combination with another carboxamide fungicide.

The invention furthermore relates to the use of a compound of the general formula (I) for preparing a fungicidal preparation for the preventative control of fungi in crop plants, in particular when resistances have already been observed. Likewise, the present invention relates to the use of a compound of the general formula (I) for preventing cross-resistances in the control of fungi on crop plants.

The abovementioned active substances of the general formula (I) can be employed in particular for controlling Plasmopara viticola, for example on grapevines.

Moreover, the compounds of the general formula (I) are also suitable for controlling harmful fungi from the class Peronosporomyctes (Oomycetes), such as,
a) Peronospora species on cabbage and bulb plants, such as, for example, P. brassicae on cabbage or P. destructor on onions,
b) Phytophthora infestans on potatoes and tomatoes,
c) Phytophthora species on various plants such as, for example, P. capsici on capsicum,
d) Plasmopara viticola on grapevines,
e) Pseudoperonospora on various plants such as, for example, P. cubensis on cucumber or P. humili on hops,
f) Pythium spp. on turf, rice, corn, cotton, oilseed rape, sunflowers, sugarbeet, vegetables and other plants such as, for example, P. ultimum on various plants, P. aphanidermatum on turf,
g) Sclerospora species on various plants, such as, for example, S. graminicola on sorghum/millet.

A large number of resistances to carboxamide fungicides have already been developed in various strains of the abovementioned pathogens. In the light of the spreading of harmful fungi which have developed resistances, the present invention is based on a control method by means of which such resistant fungal strains can be controlled efficiently and at low cost, using active substances which are currently available.

It is known that the pathogens which have developed a resistance to certain active substances are frequently also cross-resistant to these [see, for example, Lyr, H.; “Modern Selective Fungicides”; chapter 12, Gustav Fischer Verlag, Jena, Stuttgart, New York (1995)].

Surprisingly, it has now been found that harmful fungi which are resistant to carboxamide fungicides can be efficiently controlled with compounds of the general formula (I) when the compounds are employed preventatively.

The method according to the invention is preferably suitable for the preventative control of harmful Plasmopara fungi, in particular Plasmopara viticola strains. Plasmopara viticola, downy mildew of grapevine, is also referred to as grapevine Peronospora. The fungus initially forms roundish, yellowish, oily transparent flecks on the upper side of the grapevine leaves, and later, during moist and warm weather, a dense white fungal lawn on the underside of the leaves.

The lesions soon turn brown and dry. The leaves which have been damaged to a higher degree drop prematurely (“leaf drop disease”). All other green parts of the grapevine, the shoots, vines and inflorescences can also be attacked in the same manner as the leaves and young berries. Berries, for example, turn brown and shrivel. The fungus Plasmopara viticola enters the tissue of the green grapevine organs via the stomata. Infection then takes place via zoospores which float in a film of water. They settle in the vicinity of stomata and form a germinal tube. The fungus withdraws valuable nutrients from the host plant with the aid of haustoria.

The disease is economically particularly important because of the possibility of an epidemic-like development, and the infection of the grapes can mean severe yield losses up to a total failure of the harvest. Moreover, the infection with Plasmopara increases the sensitivity of the grapevine plant to frost.

The abovementioned method is employed by treating the fungi, or the plants, seeds, materials and/or the soil to be protected from fungal attack with a fungicidally active amount of the compound of the formula (I). The application can be effected both before and around the time of infection, but preferably before the infection of the materials, plants or seeds by the fungi.

The compounds of the formula (I) can be prepared by customary processes. They can be converted into the customary formulations, for example solutions, emulsions, suspensions, dusts, powders, pastes and granules. The use form depends on the intended purpose; in any case, it should ensure a fine and uniform distribution of the compound according to the invention.

The formulations are prepared in the known manner, for example by extending the active substance with solvents and/or carriers, if desired using emulsifiers and dispersants.

Suitable solvents/adjuvants are essentially:
a) water, aromatic solvents (for example Solvesso products, xylene), paraffins (for example mineral oil fractions), alcohols (for example methanol, butanol, pentanol, benzyl alcohol), ketones (for example cyclohexanone, gam ma-butryolactone), pyrrolidones (NMP, NOP), acetates (glycol diacetate), glycols, fatty acid dimethylamides, fatty acids and fatty acid esters. In principle, solvent mixtures may also be used.
b) Carriers such as ground natural minerals (e.g. kaolins, clays, talc, chalk) and ground synthetic minerals (e.g. highly disperse silica, silicates); emulsifiers such as nonionic and anionic emulsifiers (e.g. polyoxyethylene fatty alcohol ethers, alkylsulfonates and arylsulfonates) and dispersants such as lignin-sulfite waste liquors and methylcellulose.

Suitable surfactants are alkali metal, alkaline earth metal and ammonium salts of lignosulfonic acid, naphthalenesulfonic acid, phenolsulfonic acid, dibutylnaphthalenesulfonic acid, alkylarylsulfonates, alkyl sulfates, alkylsulfonates, fatty alcohol sulfates, fatty acids and sulfated fatty alcohol glycol ethers, furthermore condensates of sulfonated naphthalene and naphthalene derivatives with formaldehyde, condensates of naphthalene or of naphthalenesulfonic acid with phenol and formaldehyde, polyoxyethylene octylphenol ether, ethoxylated isooctylphenol, octylphenol, nonylphenol, alkylphenol polyglycol ether, tributylphenyl polyglycol ether, tristerylphenyl polyglycol ether, alkylaryl polyether alcohols, alcohol and fatty alcohol ethylene oxide condensates, ethoxylated castor oil, polyoxyethylene alkyl ethers, ethoxylated polyoxypropylene, lauryl alcohol polyglycol ether acetal, sorbitol esters, lignin-sulfite waste liquors and methylcellulose.

Substances which are suitable for the preparation of directly sprayable solutions, emulsions, pastes or oil dispersions are mineral oil fractions of medium to high boiling point, such as kerosene or diesel oil, furthermore coal tar oils and oils of vegetable or animal origin, aliphatic, cyclic and aromatic hydrocarbons, for example toluene, xylene, paraffin, tetrahydronaphthalene, alkylated naphthalenes or their derivatives, methanol, ethanol, propanol, butanol, cyclohexanol, cyclohexanone, isophorone, strongly polar solvents, for example dimethyl sulfoxide, N-methylpyrrolidone or water.

Powders, materials for spraying and dusts can be prepared by mixing or concomitantly grinding the active substances together with a solid carrier.

Granules, for example coated granules, impregnated granules and homogeneous granules, can be prepared by binding the active substances to solid carriers. Examples of solid carriers are mineral earths such as silica gels, silicates, talc, kaolin, attaclay, limestone, lime, chalk, bole, loess, clay, dolomite, diatomaceous earth, calcium sulfate, magnesium sulfate, magnesium oxide, ground synthetic materials, fertilizers, such as, for example, ammonium sulfate, ammonium phosphate, ammonium nitrate, ureas, and products of vegetable origin, such as cereal meal, tree bark meal, wood meal and nutshell meal, cellulose powders and other solid carriers.

Formulations for the treatment of seed may additionally comprise binders and/or gelling agents and, if appropriate, colorants.

Binders may be added in order to increase the adhesion of the active substances on the seed after the treatment. Examples of suitable binders are EO/PO block copolymer surfactants, but also polyvinyl alcohols, polyvinylpyrrolidones, polyacrylates, poly-methacrylates, polybutenes, polyisobutylenes, polystyrenes, polyethyleneamines, poly-ethyleneamides, polyethyleneimines (Lupasol®, Polymin®), polyethers, polyurethanes, polyvinyl acetates, tyloses and copolymers of these polymers. A suitable gelling agent is, for example, carrageenan (Satiagel®).

In general, the formulations comprise between 0.01 and 955% by weight, preferably between 0.1 and 90% by weight, of the active substance. The active substances are employed in a purity of from 90% to 100%, preferably 95% to 100% (according to NMR spectrum).

The active substance concentrations in the ready-to-use preparations can be varied within a substantial range. In general, they are between 0.0001 and 10%, preferably between 0.01 and 1%.

The active substances can also be used successfully by the ultra-low-volume method (ULV), where it is possible to apply formulations comprising more than 95% by weight of active substance, or even the active substance without additions.

For the treatment of seed, the relevant formulations are diluted by a factor of two to ten and will then contain the active substance in concentrations of from 0.01 to 60% by weight, preferably 0.1 to 40% by weight, in the preparations which are now ready for use.

Examples of customary formulations are:

Products for Dilution with Water

### A) Soluble Concentrates (SL)

10 parts by weight of a compound I according to the invention are dissolved in 90 parts by weight of water or a water-soluble solvent. Alternatively, wetters or other auxiliaries are added. The active substance dissolves upon dilution with water. This gives a formulation with an active substance content of 10% by weight.

### B) Dispersible Concentrates (DC)

20 parts by weight of a compound I according to the invention are dissolved in 70 parts by weight of cyclohexanone with addition of 10 parts by weight of a dispersant, for example polyvinylpyrrolidone. Dilution with water gives a dispersion. The active substance content is 20% by weight.

### C) Emulsifiable Concentrates (EC)

15 parts by weight of a compound I according to the invention are dissolved in 75 parts by weight of xylene with addition of calcium dodecylbenzenesulfonate and castor oil ethoxylate (in each case 5 parts by weight). Dilution with water gives an emulsion. The formulation has an active substance content of 15% by weight.

### D) Emulsions (EW, EO)

25 parts by weight of a compound I according to the invention are dissolved in 35 parts by weight of xylene with addition of calcium dodecylbenzenesulfonate and castor oil ethoxylate (in each case 5 parts by weight). This mixture is introduced into 30 parts by weight of water by means of an emulsifier (Ultraturrax) and made into a homogeneous emulsion. Dilution with water gives an emulsion. The formulation has an active substance content of 25% by weight.

### E) Suspensions (SC, OD)

In an agitated ball mill, 20 parts by weight of a compound I according to the invention are milled with addition of 10 parts by weight of dispersants and wetters and 70 parts by weight of water or an organic solvent to give a fine active substance suspension. Dilution with water gives a stable suspension of the active substance. The active substance content in the formulation is 20% by weight.

### F) Water-Dispersible Granules and Water-Soluble Granules (WG, SG)

50 parts by weight of a compound I according to the invention are ground finely with addition of 50 parts by weight of dispersants and wetters and made into water-dispersible or water-soluble granules by means of technical appliances (for example extrusion, spray tower, fluidized bed). Dilution with water gives a stable dispersion or solution of the active substance. The formulation has an active substance content of 50% by weight.

### G) Water-Dispersible Powders and Water-Soluble Powders (WP, SP)

75 parts by weight of a compound I according to the invention are ground in a rotorstator mill with addition of 25 parts by weight of dispersants and wetters and with silica gel. Dilution with water gives a stable dispersion or solution of the active substance. The active substance of the formulation is 75% by weight.

### Products to be Applied Undiluted

### H) Dustable Powders (DP)

5 parts by weight of a compound I according to the invention are ground finely and mixed intimately with 95 parts by weight of finely divided kaolin. This gives a dustable product with an active substance content of 5% by weight.

### J) Granules (GR, FG, GG, MG)

0.5 part by weight of a compound I according to the invention is ground finely and associated with 99.5 parts by weight of carriers. Common methods are extrusion, spray drying or the fluidized bed. This gives granules to be applied undiluted which have an active substance content of 0.5% by weight.

### K) ULV Solutions (UL)

10 parts by weight of a compound I according to the invention are dissolved in 90 parts by weight of an organic solvent, for example xylene. This gives a product to be applied undiluted, with an active substance content of 10% by weight.

The active substances can be used as such, in the form of their formulations or the use forms prepared therefrom, e.g. in the form of directly sprayable solutions, powders, suspensions or dispersions, emulsions, oil dispersions, pastes, dusts, materials for spraying, granules, by spraying, atomizing, dusting, spreading or pouring. The use forms depend entirely on the intended purposes; it is intended to ensure in each case the finest possible distribution of the active substances according to the invention.

Aqueous use forms can be prepared from emulsion concentrates, pastes or wettable powders (sprayable powders, oil dispersions) by adding water. To prepare emulsions, pastes or oil dispersions, the substances, as such or dissolved in an oil or solvent, can be homogenized in water by means of a wetter, tackifier, dispersant or emulsifier. Alternatively, it is also possible to prepare concentrates composed of active substance, wetter, tackifier, dispersant or emulsifier and, if appropriate, solvent or oil, and such concentrates are suitable for dilution with water.

Various types of oils, and wetters, adjuvants, herbicides, fungicides, other pesticides, bactericides, may be added to the active substances, if appropriate just immediately prior to use (tank mix). These agents can be admixed to the compositions of the invention in a weight ratio of 1:100 to 100:1, preferably 1:10 to 10:1.

Adjuvants within this meaning are, in particular, organically modified polysiloxanes, for example Break Thru S 240®; alcohol alkoxylates, for example Atplus 245®, Atplus MBA 1303®, Plurafac LF 300® and Lutensol ON 30®; EO/PO block polymers, for example Pluronic RPE 2035® and Genapol B®; alcohol ethoxylates, for example Lutensol XP 80®; and sodium dioctyl sulfosuccinate, for example Leophen RA®.

The application rates upon application are between 1 to 1000 g, preferably 20 to 750 g, of active substance per ha, depending on the severity of the attack and the nature of the desired effect. In general, the fungicidal compositions according to the invention comprise between 0.1 and 95, preferably between 0.5 and 90, % by weight of one or more active substances. In the treatment of seed, amounts of active substance of from 1 to 1000 g, preferably 1 to 200 g, in particular 5 to 100 g, are generally required per kilogram of seed. When used in the protection of materials and stored products, the application rate of active substance depends on the nature of the field of application and of the desired effect. Customary application rates in the protection of materials are, for example, 0.001 g to 2000 g, preferably 0.005 g to 1000 g of active substance per cubic meter of treated material.

In the method according to the invention, compounds of the general formula (I) can also be applied in combination with other active substances, for example with herbicides, insecticides, growth regulators, further fungicides or else with fertilizers. When mixing the preparations comprising the compound of the formula (I) with other fungicides, a widening of the fungicidal spectrum of action is obtained in many cases.

The following list of fungicides, together with which the compounds according to the invention can be used, is intended to illustrate the possible combinations:

### a) Strobilurins

azoxystrobin, dimoxystrobin, enestroburin, fluoxastrobin, kresoxim-methyl, metominostrobin, picoxystrobin, pyraclostrobin, trifloxystrobin, orysastrobin, methyl (2-chloro-5-[1-(3-methylbenzyloxyimino)ethyl]benzyl)carbamate, methyl (2-chloro-5-[1-(6-methylpyridin-2-ylmethoxyimino)ethyl]benzyl)carbamate, methyl 2-(ortho-(2,5-dimethylphenyloxymethylene)phenyl)-3-methoxyacrylate;

### b) Carboxamides

carboxanilides: benalaxyl, benodanil, boscalid, carboxin, mepronil, fenfuram, fenhexamid, flutolanil, furametpyr, metalaxyl, ofurace, oxadixyl, oxycarboxin, penthiopyrad, thifluzamide, tiadinil, N-(4′-bromobiphenyl-2-yl)-4-difluoromethyl-2-methylthiazole-5-carboxamide, N-(4′-trifluoromethylbiphenyl-2-yl)-4-difluoromethyl-2-methylthiazole-5-carboxamide, N-(4′-chloro-3′-fluorobiphenyl-2-yl)-4-difluoro-methyl-2-methylthiazole-5-carboxamide, N-(3′,4′-dichloro-4-fluorobiphenyl-2-yl)-3-difluoromethyl-1-methylpyrazole-4-carboxamide, N-(3′,4′-dichloro-5-fluorobiphenyl-2-yl)-3-difluoromethyl-1-methylpyrazole-4-carboxamide, N-(2-cyanophenyl)-3,4-dichloroisothiazole-5-carboxamide;
carboxylic acid morpholides: dimethomorph, flumorph;
benzoamides: flumetover, fluopicolide (picobenzamide), zoxamide;
other carboxamides: carpropamide, diclocymet, mandipropamid, N-(2-(4-[3-(4-chlorophenyl)prop-2-ynyloxy]-3-methoxyphenyl)ethyl)-2-methanesulfonylamino-3-methylbutyramide, N-(2-(4-[3-(4-chlorophenyl)prop-2-ynyloxy]-3-methoxyphenyl)-ethyl)-2-ethanesulfonylamino-3-methylbutyramide;

### c) Azoles

triazoles: bitertanol, bromuconazole, cyproconazole, difenoconazole, diniconazole, enilconazole, epoxiconazole, fenbuconazole, flusilazole, fluquinconazole, flutriafol, hexaconazole, imibenconazole, ipconazole, metconazole, myclobutanil, penconazole, propiconazole, prothioconazole, simeconazole, tebuconazole, tetraconazole, triadimenol, triadimefon, triticonazole;
imidazoles: cyazofamid, imazalil, pefurazoate, prochloraz, triflumizole;
benzimidazoles: benomyl, carbendazim, fuberidazole, thiabendazole;
others: ethaboxam, etridiazole, hymexazole;

### d) Nitrogen-Containing Heterocyclyl Compounds

pyridines: fluazinam, pyrifenox, 3-[5-(4-chlorophenyl)-2,3-dimethylisoxazolidin-3-yl]pyridine;
pyrimidines: bupirimate, cyprodinil, ferimzone, fenarimol, mepanipyrim, nuarimol, pyrimethanil;
piperazines: triforine;
pyrroles: fludioxonil, fenpiclonil;
morpholines: aldimorph, dodemorph, fenpropimorph, tridemorph;
dicarboximides: iprodione, procymidone, vinclozoline;
others: acibenzolar-s-methyl, anilazine, captan, captafol, dazomet, diclomezine, fenoxanil, folpet, fenpropidine, famoxadone, fenamidone, octhilinone, probenazole, proquinazid, pyroquilone, quinoxyfen, tricyclazole, 5-chloro-7-(4-methylpiperidin-1-yl)-6-(2,4,6-trifluorophenyl)[1,2,4]triazolo[1,5-a]pyrimidine, 2-butoxy-6-iodo-3-propyl-chromen-4-one, N,N-dimethyl-3-(3-bromo-6-fluoro-2-methylindole-1-sulfonyl)-[1,2,4]triazole-1-sulfonamide;

### e) Carbamates and Dithiocarbamates

dithiocarbamates: ferbam, mancozeb, maneb, metiram, metam, propineb, thiram, zineb, ziram;
   carbamates: diethofencarb, flubenthiavalicarb, iprovalicarb, propamocarb, methyl 3-(4-chlorophenyl)-3-(2-isopropoxycarbonylamino-3-methylbutyrylamino)-propionate, N-(1-(1-(4-cyanophenyl)ethanesulfonyl)but-2-yl)carbamic acid (4-fluorophenyl)ester;

### f) Other Fungicides

guanidines: dodine, iminoctadine, guazatine;
antibiotics: kasugamycin, polyoxine, streptomycin, validamycin A;
organometal compounds: fentin salts;
sulfur-containing heterocyclyl compounds: isoprothiolane, dithianone;
organophosphorus compounds: edifenphos, fosetyl, fosetyl-aluminum, iprobenfos, pyrazophos, tolclofos-methyl, phosphorous acid and its salts;
organochlorine compounds: thiophanate-methyl, chlorothalonil, dichlofluanid, tolylfluanid, flusulfamide, phthalide, hexachlorobenzene, pencycuron, quintozene;
nitrophenyl derivatives: binapacryl, dinocap, dinobuton;
inorganic active substances: Bordeaux mixture, copper acetate, copper hydroxide, copper oxychloride, basic copper sulfate, sulfur;
others: spiroxamine, cyflufenamid, cymoxanil, metrafenone.

The active substances mentioned as further component, their preparation and their activity against harmful fungi are generally known, and/or they are commercially available. The following compounds are mentioned in particular:

benalaxyl, methyl N-(phenylacetyl)-N-(2,6-xylyl)-DL-alaninate (DE 29 03 612);
metalaxyl, methyl N-(methoxyacetyl)-N-(2,6-xylyl)-DL-alaninate (GB 15 00 581);
ofurace, (RS)-α-(2-chloro-N-2,6-xylylacetamido)-γ-butyrolactone [CAS RN 58810-48-3];
oxadixyl, N-(2,6-dimethylphenyl)-2-methoxy-N-(2-oxo-3-oxazolidinyl)acetamide (GB 20 58 059);
aldimorph, “4-alkyl-2,5 (or 2,6)-dimethylmorpholine”, comprising 65-75% of 2,6-dimethylmorpholine and 25-35% of 2,5-dimethylmorpholine, comprising more than 85% of 4-dodecyl-2,5 (or 2,6)-dimethylmorpholine, “alkyl” also including octyl, decyl, tetradecyl and hexadecyl with a cis/trans ratio of 1:1 [CAS RN 91315-15-0];
dodine, 1-dodecylguanidinium acetate (Plant Dis. Rep. 41, p. 1029 (1957));
dodemorph, 4-cyclododecyl-2,6-dimethylmorpholine (DE-A 1198125);
fenpropimorph, (RS)-cis-4-[3-(4-tert-butylphenyl)-2-methylpropyl]-2,6-dimethyl-morpholine (DE-A 27 52 096);
fenpropidine, (RS)-1-[3-(4-tert-butylphenyl)-2-methylpropyl]piperidine (DE-A 27 52 096);
guazatine, mixture of the reaction products obtained from the amidation of technical-grade iminodi(octamethylene)diamine, comprising various guanidines and polyamines [CAS RN 108173-90-6];
iminoctadine, 1,1′-iminodi(octamethylene)diguanidine (Congr. Plant Pathol., 1., p. 27 (1968);
spiroxamine, (8-tert-butyl-1,4-dioxaspiro[4.5]dec-2-yl)diethylamine (EP-A 281 842);
tridemorph, 2,6-dimethyl-4-tridecylmorpholine (DE-A 11 64 152);
pyrimethanil, 4,6-dimethylpyrimidin-2-ylphenylamine (DD-A 151 404);
mepanipyrim, (4-methyl-6-prop-1-ynylpyrimidin-2-yl)phenylamine (EP-A 224 339);
cyprodinil, (4-cyclopropyl-6-methylpyrimidin-2-yl)phenylamine (EP-A 310 550);
cycloheximide, 4-{(2R)-2-[(1S,3S,5S)-3,5-dimethyl-2-oxocyclohexyl]-2-hydroxyethyl}-piperidine-2,6-dione [CAS RN 66-81-9];
griseofulvin, 7-chloro-2′,4,6-trimethoxy-6′-methylspiro[benzofuran-2(3H), 1′-cyclohex-2′-ene]-3,4′-dione [CAS RN 126-07-8];
kasugamycin, 3-O-[2-amino-4-[(carboxyiminomethyl)amino]-2,3,4,6-tetradeoxy-α-D-arabino-hexopyranosyl]-D-chiro-inositol [CAS RN 6980-18-3];
natamycin, (8E,14E,16E,18E,20E)-(1R,3S,5R,7R,12R,22R,24S,25R,26S)-22-(3-amino-3,6-dideoxy-β-D-mannopyranosyloxy)-1,3,26-trihydroxy-12-methyl-10-oxo-6,11,28-trioxatricyclo[22.3.1.0^{5,7}]octacosa-8,14,16,18,20-pentaene-25-carboxylic acid [CAS RN 7681-93-8];
polyoxin, 5-(2-amino-5-O-carbamoyl-2-deoxy-L-xylonamido)-1-(5-carboxy-1,2,3,4-tetrahydro-2,4-dioxopyrimidin-1-yl)-1,5-dideoxy-β-D-allofuranuronic acid [CAS RN 22976-86-9];
streptomycin, 1,1′-{1-L-(1,3,5/2,4,6)-4-[5-deoxy-2-O-(2-deoxy-2-methylamino-α-L-glucopyranosyl)-3-C-formyl-α-L-lyxofuranosyloxy]-2,5,6-trihydroxycyclohex-1,3-ylene}diguanidine (J. Am. Chem. Soc. 69, S.1234 (1947));
bitertanol, β-([1,1′-biphenyl]-4-yloxy)-α-(1,1-dimethylethyl)-1H-1,2,4-triazole-1-ethanol (DE 23 24 020);
bromuconazole, 1-[[4-bromo-2-(2,4-dichlorophenyl)tetrahydro-2-furanyl]methyl]-1H-1,2,4-triazole (Proc. 1990 Br. Crop. Prot. Conf.—Pests Dis., Bd. 1, S. 459);
cyproconazole, 2-(4-chlorophenyl)-3-cyclopropyl-1-[1,2,4]triazol-1-ylbutan-2-ol (U.S. Pat. No. 4,664,696);
difenoconazole, 1-{2-[2-chloro-4-(4-chlorophenoxy)phenyl]-4-methyl-[1,3]dioxolan-2-ylmethyl}-1H-[1,2,4]triazole (GB-A 2 098 607);
diniconazole, (βE)-β-[(2,4-dichlorophenyl)methylene]-α-(1,1-dimethylethyl)-1H-1,2,4-triazole-1-ethanol (Noyaku Kagaku, 1983, Bd. 8, S. 575);
enilconazole (imazalil), 1-[2-(2,4-dichlorophenyl)-2-(2-propenyloxy)ethyl]-1H-imidazole (Fruits 28, S. 545, 1973);
epoxiconazole, (2RS,3SR)-1-[3-(2-chlorophenyl)-2,3-epoxy-2-(4-fluorophenyl)propyl]-1H-1,2,4-triazole (EP-A 196 038);
fenbuconazole, α-[2-(4-chlorophenyl)ethyl]-α-phenyl-1H-1,2,4-triazole-1-propanonitrile (Proc. 1988 Br. Crop Prot. Conf.—Pests Dis., Vol. 1, p. 33);
fluquinconazole, 3-(2,4-dichlorophenyl)-6-fluoro-2-[1,2,4]-triazol-1-yl-3H-quinazolin-4-one (Proc. Br. Crop Prot. Conf.—Pests Dis., 5-3, 411 (1992));
flusilazole, 1-{[bis-(4-fluorophenyl)methylsilanyl]methyl}-1H-[1,2,4]triazole (Proc. Br. Crop Prot. Conf.—Pests Dis., Vol. 1, p. 413 (1984));
flutriafol, α-(2-fluorophenyl)-α-(4-fluorophenyl)-1H-1,2,4-triazol-1-ethanol (EP-A 15 756);
hexaconazole, 2-(2,4-dichlorophenyl)-1-[1,2,4]triazol-1-yl-hexan-2-ol (CAS RN 79983-71-4);
ipconazole, 2-[(4-chlorophenyl)methyl]-5-(1-methylethyl)-1-(1H-1,2,4-triazol-1-yl-methyl)cyclopentanol (EP-A 267 778),
metconazole, 5-(4-chlorobenzyl)-2,2-dimethyl-1-[1,2,4]triazol-1-ylmethylcyclopentanol (GB 857 383);
myclobutanil, 2-(4-chlorophenyl)-2-[1,2,4]triazol-1-ylmethylpentanonitrile (CAS RN 88671-89-0);
penconazole, 1-[2-(2,4-dichlorophenyl)pentyl]-1H-[1,2,4]triazole (Pesticide Manual, 12th edition 2000, p. 712);
propiconazole, 1-[[2-(2,4-dichlorophenyl)-4-propyl-1,3-dioxolan-2-yl]methyl]-1H-1,2,4-triazole (BE 835 579);
prochloraz, N-propyl-[2-(2,4,6-trichlorophenoxy)ethyl]imidazole-1-carboxamide (U.S. Pat. No. 3,991,071);
prothioconazole, 2-[2-(1-chlorocyclopropyl)-3-(2-chlorophenyl)-2-hydroxypropyl]-2,4-dihydro-[1,2,4]triazole-3-thione (WO 96/16048);
simeconazole, α-(4-fluorophenyl)-α-[(trimethylsilyl)methyl]-1H-1,2,4-triazole-1-ethanol [CAS RN 149508-90-7],
tebuconazole, 1-(4-chlorophenyl)-4,4-dimethyl-3-[1,2,4]triazol-1-ylmethylpentan-3-ol (EP-A 40 345);
tetraconazole, 1-[2-(2,4-dichlorophenyl)-3-(1,1,2,2-tetrafluoroethoxy)propyl]-1H-1,2,4-triazole (EP-A 234 242);
triadimefon, 1-(4-chlorophenoxy)-3,3-dimethyl-1-(1H-1,2,4-triazol-1-yl)-2-butanone (BE 793 867);
triadimenol, β-(4-chlorophenoxy)-α-(1,1-dimethylethyl)-1H-1,2,4-triazole-1-ethanol (DE-A 23 24 010);
triflumizole, (4-chloro-2-trifluoromethylphenyl)-(2-propoxy-1-[1,2,4]triazol-1-yl-ethylidene)amine (JP-A 79/119 462);
triticonazole, (5E)-5-[(4-chlorophenyl)methylene]-2,2-dimethyl-1-(1H-1,2,4-triazol-1-ylmethyl)cyclopentanol (FR 26 41 277);
iprodione, isopropyl 3-(3,5-dichlorophenyl)-2,4-dioxoimidazolidine-1-carboxamide (GB 13 12 536);
myclozolin, (RS)-3-(3,5-dichlorophenyl)-5-methoxymethyl-5-methyl-1,3-oxazolidine-2,4-dione [CAS RN 54864-61-8];
procymidone, N-(3,5-dichlorophenyl)-1,2-dimethylcyclopropane-1,2-dicarboximide (U.S. Pat. No. 3,903,090);
vinclozoline, 3-(3,5-dichlorophenyl)-5-methyl-5-vinyloxazolidine-2,4-dione (DE-A 22 07 576);
ferbam, iron(3+) dimethyldithiocarbamate (U.S. Pat. No. 1,972,961);
nabam, disodium ethylenebis(dithiocarbamate) (U.S. Pat. No. 2,317,765);
maneb, manganese ethylenebis(dithiocarbamate) (U.S. Pat. No. 2,504,404);
mancozeb, manganese ethylenebis(dithiocarbamate) polymer complex zinc salt (GB 996 264);
metam, methyldithiocarbamic acid (U.S. Pat. No. 2,791,605);
metiram, zinc ammoniate ethylenebis(dithiocarbamate) (U.S. Pat. No. 3,248,400);
propineb, zinc propylenebis(dithiocarbamate) polymer (BE 611 960);
polycarbamate, bis(dimethylcarbamodithioato-κS,κS′)[μ-[[1,2-ethanediylbis[carbamodithioato-κS,κS′]](2-)]]di[zinc] [CAS RN 64440-88-6];
thiram, bis(dimethylthiocarbamoyl)disulfide (DE-A 642 532);
ziram, dimethyl dithiocarbamate [CAS RN 137-30-4];
zineb, zinc ethylenebis(dithiocarbamate) (U.S. Pat. No. 2,457,674);
anilazine, 4,6-dichloro-N-(2-chlorophenyl)-1,3,5-triazine-2-amine (U.S. Pat. No. 2,720,480);
benomyl, N-butyl-2-acetylaminobenzimidazole-1-carboxamide (U.S. Pat. No. 3,631,176);
boscalid, 2-chloro-N-(4′-chlorobiphenyl-2-yl)nicotinamide (EP-A 545 099);
carbendazim, methyl (1H-benzimidazol-2-yl)carbamate (U.S. Pat. No. 3,657,443);
carboxin, 5,6-dihydro-2-methyl-N-phenyl-1,4-oxathiine-3-carboxamide (U.S. Pat. No. 3,249,499);
oxycarboxin, 5,6-dihydro-2-methyl-1,4-oxathiine-3-carboxanilide 4,4-dioxide (U.S. Pat. No. 3,399,214);
cyazofamid, 4-chloro-2-cyano-N,N-dimethyl-5-(4-methylphenyl)-1H-imidazole-1-sulfonamide (CAS RN 120116-88-3];
dazomet, 3,5-dimethyl-1,3,5-thiadiazinane-2-thione (Bull. Soc. Chim. Fr. Vol. 15, p. 891 (1897));
diflufenzopyr, 2-{1-[4-(3,5-difluorophenyl)semicarbazono]ethyl}nicotinic acid [CAS RN 109293-97-2];
dithianone, 5,10-dioxo-5,10-dihydronaphtho[2,3-b][1,4]dithiine-2,3-dicarbonitrile (GB 857 383);
famoxadon, (RS)-3-anilino-5-methyl-5-(4-phenoxyphenyl)-1,3-oxazolidine-2,4-dione [CAS RN 131807-57-3];
fenamidon, (S)-1-anilino-4-methyl-2-methylthio-4-phenylimidazolin-5-one [CAS RN 161326-34-7];
fenarimol, α-(2-chlorophenyl)-α-(4-chlorophenyl)-5-pyrimidinemethanol (GB 12 18 623);
fuberidazole, 2-(2-furanyl)-1H-benzimidazole (DE-A 12 09 799);
flutolanil, α,α,α-trifluoro-3′-isopropoxy-o-toluanilide (JP 1104514);
furametpyr, 5-chloro-N-(1,3-dihydro-1,1,3-trimethyl-4-isobenzofuranyl)-1,3-dimethyl-1H-pyrazole-4-carboxamide [CAS RN 123572-88-3];
isoprothiolan, diisopropyl 1,3-dithiolan-2-ylidenemalonate (Proc. Insectic. Fungic. Conf. 8. Vol. 2, p. 715 (1975));
mepronil, 3′-isopropoxy-o-toluanilide (U.S. Pat. No. 3,937,840);
nuarimol, α-(2-chlorophenyl)-α-(4-fluorophenyl)-5-pyrimidinemethanol (GB 12 18 623);
fluopicolid (picobenzamide), 2,6-dichloro-N-(3-chloro-5-trifluoromethylpyridin-2-ylmethyl)benzamide (WO 99/42447);
probenazole, 3-allyloxy-1,2-benzothiazole 1,1-dioxide (Agric. Biol. Chem. 37, p. 737 (1973));
proquinazid, 6-iodo-2-propoxy-3-propylquinazolin-4(3H)-one (WO 97/48684);
pyrifenox, 2′,4′-dichloro-2-(3-pyridyl)acetophenone (EZ)-O-methyl oxime (EP 49 854);
pyroquilon, 1,2,5,6-tetrahydropyrrolo[3,2,1-ij]quinolin-4-one (GB 139 43 373)
quinoxyfen, 5,7-dichloro-4-(4-fluorophenoxy)quinoline (U.S. Pat. No. 5,240,940);
silthiofam, N-allyl-4,5-dimethyl-2-(trimethylsilyl)thiophene-3-carboxamide [CAS RN 175217-20-6];
thiabendazole, 2-(1,3-thiazol-4-yl)benzimidazole (U.S. Pat. No. 3,017,415);
thifluzamid, 2′,6′-bibromo-2-methyl-4′-trifluoromethoxy-4-trifluormethyl-1,3-thiazole-5-carboxanilide [CAS RN 130000-40-7];
thiophanate-methyl, 1,2-phenylenebis(iminocarbonothioyl)bis(dimethylcarbamate) (DE-A 19 30 540);
tiadinil, 3′-chloro-4,4′-dimethyl-1,2,3-thiadiazole-5-carboxanilide [CAS RN 223580-51-6];
tricyclazole, 5-methyl-1,2,4-triazolo[3,4-b][1,3]benzothiazole [CAS RN 41814-78-2];
triforine, N,N′-{piperazine-1,4-diylbis[(trichloromethyl)methylene]}diformamide (DE-A 19 01 421);
5-chloro-7-(4-methylpiperidin-1-yl)-6-(2,4,6-trifluorophenyl)-[1,2,4]triazolo[1,5-a]pyrimidine (WO 98/46607);
Bordeaux mixture, mixture of CuSO₄×3Cu(OH)₂×3CaSO₄ [CAS RN 8011-63-0]
copper acetate, Cu(OCOCH₃)₂ [CAS RN 8011-63-0];
copper oxychloride, Cu₂Cl(OH)₃ [CAS RN 1332-40-7];
basic copper sulfate, CuSO₄ [CAS RN 1344-73-6];
binapacryl, (RS)-2-sec-butyl-4,6-dinitrophenyl 3-methylcrotonate [CAS RN 485-31-4];
dinocap, mixture of 2,6-dinitro-4-octylphenylcrotonate and 2,4-dinitro-6-octyl
-phenylcrotonate, “octyl” being a mixture of 1-methylheptyl, 1-ethylhexyl and 1-propylpentyl (U.S. Pat. No. 2,526,660);
dinobuton, (RS)-2-sec-butyl-4,6-dinitrophenyl isopropyl carbonate [CAS RN 973-21-7];
nitrothal-isopropyl, diisopropyl 5-nitroisophthalate (Proc. Br. Insectic. Fungic. Conf. 7., Vol. 2, p. 673 (1973));
fenpiclonil, 4-(2,3-dichlorophenyl)-1H-pyrrole-3-carbonitrile (Proc. 1988 Br. Crop Prot. Conf.—Pests Dis., Vol. 1, p. 65);
fludioxonil, 4-(2,2-difluorobenzo[1,3]dioxol-4-yl)-1H-pyrrole-3-carbonitrile (The Pesticide Manual, Ed.: The British Crop Protection Council, 10^{th} edition 1995, p. 482);
acibenzolar-5-methyl, methyl 1,2,3-benzothiadiazole-7-carbothioate [CAS RN 135158-54-2];
flubenthiavalicarb (benthiavalicarb), ispropyl {(S)-1-[(1R)-1-(6-fluorobenzothiazol-2-yl)ethylcarbamoyl]-2-methylpropyl}carbamate (JP-A 09/323,984);
carpropamid, 2,2-dichloro-N-[1-(4-chlorophenyl)ethyl]-1-ethyl-3-methylcyclopropane-carboxamide [CAS RN 104030-54-8];
chlorthalonil, 2,4,5,6-tetrachloroisophthalonitrile (U.S. Pat. No. 3,290,353);
cyflufenamid, (Z)-N-[α-(cyclopropylmethoxyimino)-2,3-difluoro-6-(trifluoromethyl)-benzyl]-2-phenylacetamide (WO 96/19442);
cymoxanil, 1-(2-cyano-2-methoxyiminoacetyl)-3-ethylurea (U.S. Pat. No. 3,957,847);
diclomezine, 6-(3,5-dichlorophenyl-p-tolyl)pyridazin-3(2H)-one (U.S. Pat. No. 4,052,395)
diclocymet, (RS)-2-cyano-N—[(R)-1-(2,4-dichlorophenyl)ethyl]-3,3-dimethylbutyramide [CAS RN 139920-32-4];
diethofencarb, isopropyl 3,4-diethoxycarbanilate (EP-A 78 663); edifenphos, O-ethyl S,S-diphenyl phosphorodithioate (DE-A 14 93 736)
ethaboxam, N-(cyano-2-thienylmethyl)-4-ethyl-2-(ethylamino)-5-thiazolecarboxamide (EP-A 639 574);
fenhexamide, N-(2,3-dichloro-4-hydroxyphenyl)-1-methylcyclohexanecarboxamide (Proc. Br. Crop Prot. Conf.—Pests Dis., 1998, Vol. 2, p. 327);
fentin acetate, triphenyltin (U.S. Pat. No. 3,499,086);
fenoxanil, N-(1-cyano-1,2-dimethylpropyl)-2-(2,4-dichlorophenoxy)propanamide (EP-A 262 393);
ferimzone, (Z)-2′-methylacetophenone-4,6-dimethylpyrimidin-2-ylhydrazone [CAS RN 89269-64-7];
fluazinam, 3-chloro-N-[3-chloro-2,6-dinitro-4-(trifluoromethyl)phenyl]-5-(trifluoromethyl)-2-pyridinamine (The Pesticide Manual, Ed.: The British Crop Protection Council, 10^{th} edition 1995, p. 474);
fosetyl, fosetyl-aluminum, ethylphosphonate (FR 22 54 276);
iprovalicarb, isopropyl[(1S)-2-methyl-1-(1-p-tolyl-ethylcarbamoyl)-propyl]carbamate (EP-A 472 996);
hexachlorobenzene (C. R. Seances Acad. Agric. Fr., Vol. 31, p. 24 (1945);
mandipropamid, (RS)-2-(4-chlorophenyl)-N-[3-methoxy-4-(prop-2-ynyloxy)phenethyl]-2-(prop-2-ynyloxy)acetamide (WO 03/042166);
metrafenon, 3′-bromo-2,3,4,6′-tetramethoxy-2′,6-dimethylbenzophenone (U.S. Pat. No. 5,945,567);
pencycuron, 1-(4-chlorobenzyl)-1-cyclopentyl-3-phenylurea (DE-A 27 32 257);
penthiopyrad, (RS)—N-[2-(1,3-dimethylbutyl)-3-thienyl]-1-methyl-3-(trifluoromethyl)-1H-pyrazole-4-carboxamide (JP 10/130,268);
propamocarb, propyl 3-(dimethylamino)propylcarbamate (DE-A 15 67 169);
phthalide (DE-A 16 43 347);
toloclofos-methyl, O-2,6-dichloro-ρ-tolyl O,O-dimethyl phosphorothioate (GB 14 67 561);
quintozene, pentachloronitrobenzene (DE-A 682 048);
zoxamide, (RS)-3,5-dichloro-N-(3-chloro-1-ethyl-1-methyl-2-oxopropyl)-p-toluamide [CAS RN 156052-68-5];
captafol, N-(1,1,2,2-tetrachloroethylthio)cyclohex-4-ene-1,2-dicarboximide (Phytopathology 52, p. 754 (1962));
captan, N-(trichloromethylthio)cyclohex-4-ene-1,2-dicarboximide (U.S. Pat. No. 2,553,770);
dichlofluanid, N-dichlorofluoromethylthio-N′,N′-dimethyl-N-phenylsulfamide (DE-A 11 93 498);
folpet, N-(trichloromethylthio)phthalimide (U.S. Pat. No. 2,553,770);
tolylfluanid, N-dichlorofluoromethylthio-N′,N′-dimethyl-N-p-tolylsulfamide (DE-A 11 93 498);
dimethomorph, 3-(4-chlorophenyl)-3-(3,4-dimethoxyphenyl)-1-morpholin-4-yl-propenone (EP-A 120 321);
flumetover, 2-(3,4-dimethoxyphenyl)-N-ethyl-α,α,α-trifluoro-N-methyl-p-toluamide [AGROW Nr. 243, 22 (1995)];
flumorph, 3-(4-fluorophenyl)-3-(3,4-dimethoxyphenyl)-1-morpholin-4-yl-propenone (EP-A 860 438),
N-(4′-bromobiphenyl-2-yl)-4-difluoromethyl-2-methylthiazole-5-carboxamide, N-(4′-trifluoromethylbiphenyl-2-yl)-4-difluoromethyl-2-methylthiazole-5-carboxamide, N-(4′-chloro-3′-fluorobiphenyl-2-yl)-4-difluoromethyl-2-methylthiazole-5-carboxamide, N-(3′,4′-dichloro-4-fluorobiphenyl-2-yl)-3-difluoromethyl-1-methylpyrazole-4-carboxamide (WO 03/66610),
N-(2-cyanophenyl)-3,4-dichloroisothiazole-5-carboxamide (WO 99/24413);
N-(2-(4-[3-(4-chlorophenyl)prop-2-ynyloxy]-3-methoxyphenyl)ethyl)-2-methanesulfo-nylamino-3-methylbutyramide, N-(2-(4-[3-(4-chlorophenyl)prop-2-ynyloxy]-3-methoxy-phenyl)ethyl)-2-ethanesulfonylamino-3-methylbutyramide (WO 04/49804);
3-[5-(4-chlorophenyl)-2,3-dimethylisoxazolidin-3-yl]-pyridine (EP-A 10 35 122);
2-butoxy-6-iodo-3-propylchromen-4-one (WO 03/14103);
N,N-dimethyl 3-(3-bromo-6-fluoro-2-methylindol-1-sulfonyl)-[1,2,4]-triazole-1-sulfonamide (EP-A 10 31 571);
methyl (2-chloro-5-[1-(3-methylbenzyloxyimino)ethyl]benzyl)carbamate, methyl (2-chloro-5-[1-(6-methylpyridin-2-ylmethoxyimino)ethyl]benzyl)carbamate (EP-A 12 01 648);
methyl 3-(4-chlorophenyl)-3-(2-isopropoxycarbonylamino-3-methylbutyrylamino)-propionate (EP-A 10 28 125);
azoxystrobin, methyl 2-{2-[6-(2-cyano-1-vinylpenta-1,3-dienyloxy)-pyrimidin-4-yloxy]phenyl}-3-methoxyacrylate (EP-A 382 375),
dimoxystrobin, (E)-2-(methoxyimino)-N-methyl-2[α-(2,5-xylyloxy)-o-tolyl]acetamide (EP-A 477 631);
fluoxastrobin, (E)-{2-[6-(2-chlorophenoxy)-5-fluoropyrimidin-4-yloxy]phenyl}(5,6-dihydro-1,4,2-dioxazin-3-yl)methanone O-methyloxime (WO 97/27189);
kresoxim-methyl, methyl (E)-methoxyimino[α-(o-tolyloxy)-o-tolyl]acetate (EP-A 253 213);
metominostrobin, (E)-2-(methoxyimino)-N-methyl-2-(2-phenoxyphenyl)acetamide (EP-A 398 692);
orysastrobin, N-methyl-(2E)-2-(methoxyimino)-2-{2-[(3E,5E,6E)-5-(methoxyimino)-4,6-dimethyl-2,8-dioxa-3,7-diazanona-3,6-dien-1-yl]phenyl}acetamide (WO 97/15552);
picoxystrobin, methyl 3-methoxy-2-[2-(6-trifluoromethylpyridin-2-yloxymethyl)phenyl]-acrylate (EP-A 278 595);
pyraclostrobin, methyl N-{2-[1-(4-chlorophenyl)-1H-pyrazol-3-yloxymethyl]phenyl}(N-methoxy)carbamate (WO 96/01256);
trifloxystrobin, methyl (E)-methoxyimino-{(E)-α-[1-(α,α,α-trifluoro-m-tolyl)ethylidene-aminooxy]-o-tolyl}acetate (EP-A 460 575);
methyl 2[ortho-(2,5-dimethylphenyloxymethylene)phenyl]-3-methoxyacrylate (EP-A 226 917);
5-chloro-7-(4-methylpiperidin-1-yl)-6-(2,4,6-trifluorophenyl)-[1,2,4]triazolo[1,5-a]pyrimidine (WO 98/46608);
3,4-dichloro-N-(2-cyanophenyl)isothiazole-5-carboxamide (WO 99/24413), compounds of the formula III (WO 04/049804);
N-(2-(4-[3-(4-chlorophenyl)prop-2-ynyloxy]-3-methoxyphenyl)ethyl)-2-methane-sulfonylamino-3-methylbutyramide and N-(2-(4-[3-(4-chlorophenyl)prop-2-ynyloxy]-3-methoxyphenyl)ethyl)-2-ethanesulfonylamino-3-methylbutyramide (WO 03/66609);
2-butoxy-6-iodo-3-propylchromen-4-one (WO 03/14103);
N,N-dimethyl 3-(3-bromo-6-fluoro-2-methylindole-1-sulfonyl)-[1,2,4]-triazole-1-sulfonamide (WO 03/053145);
methyl 3-(4-chlorophenyl)-3-(2-isopropoxycarbonylamino-3-methylbutyrylamino)-propanate (EP-A 1028125).

The compounds of the general formula (I) can be applied together with the abovementioned further fungicides in generally customary formulations, for example as solutions, emulsions, suspensions, dusts, powders, pastes and granules. The type of application depends on the intended purpose. The formulations are prepared by known methods.

In general, the formulations comprise between 0.01 and 95% by weight, preferably between 0.1 and 90% by weight, of active substances.

The active substance concentrations in the ready-to-use preparations can be varied within wide limits. In general, they are between 0.0001 and 10%, preferably between 0.01 and 1%. It is also possible to use the active substance successfully by the ultra-low-volume method (ULV), it being possible to apply formulations comprising more than 95% by weight of active substance, or even the active substance without additives.

Various types of oils, or wetters, adjuvants, herbicides, other fungicides, other pesticides, bactericides, can be added to the active substance of the general formula (I), if appropriate also just immediately prior to use (tank mix). These agents can be admixed with the agents according to the invention in a weight ratio of 1:10 to 10:1.

The fungicidal activity of compounds of the general formula (I) against resistant harmful fungi can be demonstrated by the following experiments:

### EXAMPLE 1

### Preparation of the Test Solutions

Starting from four different carboxamide fungicides, four stock solutions are prepared with the stated amounts of active substance in water.

Stock solution A was prepared starting from dimethomorph ((E,Z)-4-[3-(4-chlorophenyl)-3-(3,4-dimethoxyphenyl)acryloyl]morpholine) with 150 g of dispersible concentrate (d.c.) per liter.

Stock solution B was prepared starting from mandipropamid ((RS)-2-(4-chlorophenyl)-N-[3-methoxy-4-(prop-2-ynyloxy)phenethyl]-2-(prop-2-ynyloxy)acetamide) with 40 g of emulsifiable concentrate (e.c.) per liter.

Stock solution C was prepared starting from iprovalicarb (isopropyl 2-methyl-1-[(1-p-tolylethyl)carbamoyl]-(S)-propylcarbamate) as 50% water dispersible granules (w.g.).

Stock solution D was prepared starting from benthiavalicarb (isopropyl[(S)-1-{[(R)-1-(6-fluoro-1,3-benzothiazol-2-yl)ethyl]carbamoyl}-2-methylpropyl]carbamate) as 10% wettable powder (w.p.).

### EXAMPLE 2

Study on the activity of the four carboxamide fungicides against sensitive and resistant Plasmopara viticola strains.

Four-week old grapevine plants (Riesling) with 6-8 leaves are treated with 50 ml of a solution which contains the harmful fungi (200 000 spores of the fungus Plasmopara viticola per milliliter). Tests are carried out both with sensitive and with resistant strains.

The fungicidal active substances described in Example 1 are applied both one day before the treatment with the harmful fungi (preventative treatment) and in each case one day after the treatment with the harmful fungi (curative treatment). After the treatment with the harmful fungi, the plants are left to stand overnight at 95% atmospheric humidity and a temperature of 18° C. This is followed by a 6-day observation phase and a final evaluation on day 6, the test plants being exposed to daylight for 12 hours and left to stand in the dark for 12 hours.

To promote spore development, the undersides of the grapevine leaves are sprayed with water 24 hours before carrying out the final evaluation and left to stand.

The experiments are evaluated by determining the percentage of diseased leaf area of each plant. A high percentage means a high disease level caused by the harmful fungus, while a low percentage means a low disease level caused by the harmful fungus.

### Results:

For the plants treated curatively with stock solution A, a diseased leaf area of 70% was found for the resistant fungi and a leaf area of 0% for the sensitive fungi. In the case of the preventative treatment, a diseased leaf area of 0.5% was found for the resistant fungi and a disease level of 0% for the sensitive fungi.

In the case of the plants treated with stock solution B, curative treatment resulted in a disease level of 65% of the leaf area for the resistant fungi and a disease level of 0% for the sensitive fungi. In the case of preventative treatment, a disease level of 8% of the leaf area resulted for the resistant fungi and a disease level of 0% of the leaf area for the sensitive fungi.

In the case of the plants treated with stock solution C, curative treatment resulted in a disease level of 75% of the leaf area for the resistant fungi and a disease level of 0% for the sensitive fungi. In the case of preventative treatment, a disease level of 70% of the leaf area resulted for the resistant fungi and a disease level of 0% of the leaf surface area for the sensitive fungi.

In the case of the plants treated with stock solution D, curative treatment resulted in a disease level of 70% of the leaf area for the resistant fungi and a disease level of 0% for the sensitive fungi. In the case of preventative treatment, a disease level of 55% of the leaf surface area resulted for the resistant fungi and a disease level of 0% of the leaf surface area for the sensitive fungi.

In a control experiment in which the test plants were sprayed only with a test solution without active substance, curative treatment resulted in a disease level of 68% of the area for the resistant fungi and a disease level of 65% of the area for the sensitive fungi. In the comparative experiment with preventative treatment, an area of 75% of the surface area resulted when applying the treatment to the resistant fungi and a disease level of 80% of the area in the sensitive fungi.

It can be seen from these comparative studies that all four fungicidal active substances (carboxamide fungicides) show a high activity in the curative and preventative treatment of sensitive fungal strains.

In the case of the resistant fungal strains, in contrast, the preventative treatment with dimethomorph and the treatment with mandipropamid proved to be effective, whereas the treatment with iprovalicarb and benthiavalicarb gave no satisfactory results.

1-12. (canceled)

13. A method of controlling harmful fungi which are resistant to carboxamide fungicides, comprising applying a fungicidally active amount of a compound of formula (I) 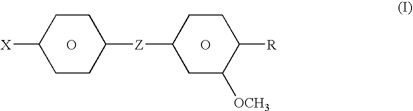
wherein —R denotes:
—OCH₃, —OC₂H₅ or —OCH₂—C≡CH
wherein —X denotes either —Cl or —F
and
wherein —Z— denotes: 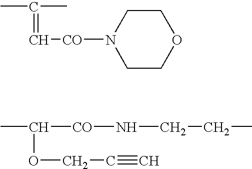
or
preventatively to the plants, the seeds and/or the soils before or after the plants are sown or before or after the plants have emerged.

14. The method of claim 13, wherein said harmful fungi controlled are Plasmopara, Peronospora, Phytophthora, Pseudoperonospora, Pythium and/or Sclerospora species.

15. The method of claim 13, wherein said compound of formula (I)
—R denotes:
—OCH₃, —OC₂H₅ or —OCH₂—C≡CH
—X denotes —Cl or —F
and —Z— denotes

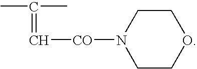

16. The method of claim 14, wherein in said compound of formula (I)
—R denotes:
—OCH₃, —OC₂H₅ or —OCH₂—C≡CH
—X denotes —Cl or —F
and —Z— denotes

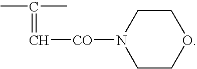

17. The method of claim 13, wherein in said compound of formula (I)
—R denotes:
—OCH₃, —OC₂H₅ or —OCH₂—C≡CH
—X denotes —Cl
and —Z— denotes

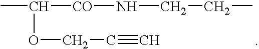

18. The method of claim 14, wherein in said compound of formula (I)
—R denotes:
—OCH₃, —OC₂H₅ or —OCH₂—C≡CH
—X denotes —Cl
and —Z— denotes

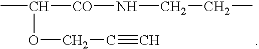

19. The method of claim 15, wherein in said compound of formula (I)
—R denotes:
—OCH₃, —OC₂H₅ or —OCH₂—C≡CH
—X denotes —Cl
and —Z— denotes

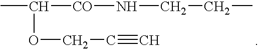

20. The method of claim 13, wherein said compound of formula (I) is applied in an amount of from 1 to 1000 g/ha.

21. The method of claim 14, wherein said compound of formula (I) is applied in an amount of from 1 to 1000 g/ha.

22. The method of claim 15, wherein said compound of formula (I) is applied in an amount of from 1 to 1000 g/ha.

23. The method of claim 13, wherein said compound of formula (I) is applied in amounts of from 1 to 1000 g/100 kg of seed.

24. The method of claim 14, wherein said compound of formula (I) is applied in amounts of from 1 to 1000 g/100 kg of seed.

25. The method of claim 15, wherein said compound of formula (I) is applied in amounts of from 1 to 1000 g/100 kg of seed.

26. The method of claim 13, wherein said compound of formula (I) is applied to the underside of the leaves of said plants to be treated.

27. The method of claim 14, wherein said compound of formula (I) is applied to the underside of the leaves of said plants to be treated.

28. The method of claim 15, wherein said compound of formula (I) is applied to the underside of the leaves of said plants to be treated.

29. The method of claim 13, wherein said plants are grapevines.

30. The method of claim 13, wherein said compound of the general formula (I) is applied in combination with another fungicide.

31. The method of claim 13, wherein said compound of formula (I) is applied in combination with another carboxamide fungicide.
